(19) United States
(12) Patent Application Publication
(10) Pub. No.: US 2024/0141589 A1
(43) Pub. Date: May 2, 2024

(54) METHOD AND DEVICE FOR PRODUCING AN MFC FILM

(71) Applicant: Stora Enso OYJ, Helsinki (FI)

(72) Inventors: Otto Nylèn, Helsinki (FI); Kaj Backfolk, Lappeenranta (FI)

(73) Assignee: Stora Enso OYJ, Helsinki (FI)

(21) Appl. No.: 18/547,375

(22) PCT Filed: Feb. 23, 2022
(86) PCT No.: PCT/IB2022/051587

§ 371 Date: Aug. 22, 2023

(30) Foreign Application Priority Data
Feb. 26, 2021 (SE) 2150209-1

(51) Int. Cl. D21F 1/02; B05C 5/02; D21H 11/16

(52) U.S. Cl. CPC D21F 1/026; B05C 5/0254; D21F 1/028; D21H 11/16

(57) ABSTRACT

A method of casting an MFC film on a substrate (52) comprises providing an MFC dispersion having a solids content of 2.5-25% by weight, and a viscosity above 4 Pas at a shear rate of 20 s⁻¹; exposing the MFC dispersion to a first shearing step (9), providing a shear rate of above 10 s⁻¹; introducing the MFC dispersion into a film forming device (4), laterally distributing (41) the MFC dispersion: exposing the distributed MFC dispersion to a second shearing step (42), providing a shear rate of above 100 s⁻¹; decelerating (43) the distributed MFC dispersion: exposing the MFC dispersion to a third shearing step (44), providing a shear rate of above 100 s⁻¹; and simultaneously with, or subsequent to, the third shearing step (44), depositing the MFC dispersion on the substrate to form a wet MFC film on the substrate.

### TECHNICAL FIELD

The present disclosure relates to a method and a device for producing MFC films. The disclosure relates particularly to a method and a device which provide a high quality MFC film.

### BACKGROUND

Microfibrillated cellulose (“MFC”) shall in the context of the patent application mean a cellulose particle, fiber or fibril having a width or diameter of from 20 nm to 1000 nm.

Various methods exist to make MFC, such as single or multiple pass refining, pre-hydrolysis followed by refining or high shear disintegration or liberation of fibrils. One or several pre-treatment steps is usually required in order to make MFC manufacturing both energy efficient and sustainable. The cellulose fibers of the pulp used when producing MFC may thus be native or pre-treated enzymatically or chemically, for example to reduce the quantity of hemicellulose or lignin. The cellulose fibers may be chemically modified before fibrillation, wherein the cellulose molecules contain functional groups other (or more) than found in the original cellulose. Such groups include, among others, carboxymethyl (CM), aldehyde and/or carboxyl groups (cellulose obtained by N-oxyl mediated oxidation, for example “TEMPO”), or quaternary ammonium (cationic cellulose). After being modified or oxidized in one of the above-described methods, it is easier to disintegrate the fibers into MFC.

MFC can be produced from wood cellulose fibers, both from hardwood or softwood fibers. It can also be made from microbial sources, agricultural fibers such as wheat straw pulp, bamboo, bagasse, or other non-wood fiber sources. It can be made from pulp, including pulp from virgin fiber, e.g. mechanical, chemical and/or thermomechanical pulps. It can also be made from broke or recycled paper.

Current research indicates that MFC may be a suitable material for packaging and coating of packaging, due to its barrier properties. Hence, MFC has the potential of replacing or supplementing currently used barrier films, including polymer and metal films.

Forming of MFC films can be achieved by solvent casting of a viscous or gel-like fluid material on a continuous conveyor belt, followed by dewatering/drying (e.g. evaporation) of the solvent.

The term “solvent casting” is a known term designating methods wherein a film is produced by applying a wet film comprising a film forming component which is distributed in a medium that is to be essentially removed, for example by dewatering and/or evaporation. The film forming component may be dispersed in a dispersing medium or dissolved in a solvent, hence the term “solvent casting”.

In the following, the term “MFC dispersion” will be used as reference to a dispersion/suspension or solution containing MFC. The MFC dispersion will be in a viscous state.

Forming a film from the MFC dispersion presents a challenge, in that it has very high viscosity, and thus does not flow freely as a normal liquid would. Moreover, the MFC dispersion has a tendency to flocculate and clog flow channels and cavities in the casting device and other equipment used up stream of the point where the MFC dispersion is applied to the substrate on which the MFC film is to be cast.

A known solution is to dilute the MFC dispersion. However, such dilution is associated with a considerable increase in the cost of drying the cast film.

The low viscosity of the diluted MFC dispersion also causes problems when a coating or film is deposited on the substrate, as it has tendency to spill and dribble, especially in high speed movement of the substrate.

Furthermore, in fabrication of free-standing films, the edge profile of the MFC film needs to be very steep. This requires certain minimum level of viscosity, and with low viscous dilute MFC dispersion, the layer of wet MFC dispersion will pour down and form indistinct edges that are not sharp. These edges dry faster than the rest of the film, which creates many problems, such as deviating adhesion from the substrate and ripping of the film at the point where MFC film is to be detached from the substrate.

Hence, there is a need for improvements in the casting of an MFC dispersion on a substrate.

### SUMMARY

It is an object to provide a method and a system, which provide improved MFC film quality, preferably with limited or no increase in production cost and more preferably with a reduction in production cost.

The invention is defined by the appended independent claims, with embodiments being set forth in the appended dependent claims, in the following description and in the attached drawings.

According to a first aspect, there is provided a method of casting an MFC film on a substrate, comprising providing an MFC dispersion having a solids content of about 2.5-25% by weight, preferably about 2.5-15% by weight, about 2.5-10% by weight or about 2.5-8% by weight, and a viscosity which is above 4 Pas at a shear rate of 20 s⁻¹; exposing the MFC dispersion to a first shearing step, which provides a shear rate of above 10 s⁻¹, preferably above 20 s⁻¹ or above 30 s⁻¹; introducing the MFC dispersion into a film forming device; in the film forming device, laterally distributing the MFC dispersion; in the film forming device, subsequent to the distributing, exposing the distributed MFC dispersion to a second shearing step, providing a shear rate of above 100 s⁻¹, preferably above 200 s⁻¹; in the film forming device, subsequent to the second shearing step, decelerating the distributed MFC dispersion, such that the shear rate is reduced; in the film forming device, exposing the distributed MFC dispersion to a third shearing step, providing a shear rate of above 100 s⁻¹, preferably above 200 s⁻¹; and simultaneously with, or subsequent to, the third shearing step, depositing the MFC dispersion on the substrate, while moving the substrate relative to the film forming device, such that a wet MFC film is formed on the substrate.

A “film forming device” or an “applicator” is the device that receives the MFC dispersion and forms the film coating onto the substrate.

The MFC dispersion may be distributed over all or part of a width of the film forming device. Hence, while the distribution width may essentially correspond to a width of the device, it may be either smaller or greater than this width. In particular, the MFC dispersion may be distributed over a width that may essentially correspond to a width of the produced MFC film, but it may also be smaller or larger than the produced film width. In addition, the steps subsequent to the distribution may be performed in widths larger or smaller than the distribution width.

The substrate may be a metal belt, such as a polished metal belt, a polymer film, a polymer membrane, a paper or paperboard sheet or a ceramic substrate.

The film that is being formed may be formed so as to correspond to a dry layer thickness of 5-60 μm.

Applicant has found that by following these steps, an MFC layer can be made from an MFC dispersion containing a film forming component and a medium, with the MFC dispersion having a solids content about 2.5-4% by weight, about 4-6% by weight, about 6-8% by weight, about 8-10% by weight, about 10-12% by weight, about 12-14% by weight, about 14-16% by weight, about 16-18% by weight, about 18-20% by weight, about 20-22% by weight or about 22-25% by weight, which is considered a high solids content MFC. Preferably, the solids content may be greater than 3% or greater than 4% by weight.

A content of the medium of the MFC dispersion may be at least 75% by weight, preferably more than 80% by weight, more than 85% by weight, more than 90% by weight or more than 95% by weight. The film forming component may comprise, consist or consist essentially of MFC, optionally with one or more water soluble polymers which may operate as co-additives and/or co-film formers.

The medium may comprise water and optionally one or more solvents.

In the context of the present application, a dry film is a film having a medium content of 0.1-15% by weight.

The film forming component may be dispersed in a dispersing medium, whereby the dispersing medium is to be essentially removed. Alternatively, the film forming component may be dissolved in a solvent, whereby the solvent is to be essentially removed. In any event, the MFC dispersion is in a viscous liquid stage when the casting takes place.

The film forming component may comprise MFC and one or more property-modifying additives and/or fillers. Preferably, the film forming component comprises at least 50% by weight of MFC, preferably at least 60%, at least 70% or at least 80% MFC. For example, the film forming component may also comprise other natural fibre material in addition to the MFC.

Hence, in the MFC dispersion, the MFC content may be about 1.25% by weight to about 25% by weight, preferably about 1.8% by weight to about 10% by weight or about 2.8% by weight to about 8% by weight.

The film forming component optionally also comprises a water soluble polymer that can form a film and/or improve bonding between cellulose fibrils. Typical example of such polymers are e.g. natural gums or polysaccharides or derivatives thereof such as e.g. CMC, starch, or PVOH or analogues thereof.

The viscosity may be determined for a dispersion at a temperature of about 20-80 deg C. and preferably about 20-60 deg C. A preferred method of measuring viscosity is by use of a rheometer using bop-cup mode, such as an Anton Paar MCR 302 dynamic rotational rheometer.

By thus increasing the solids content of the MFC dispersion, it is possible to provide a film which has improved quality, in particular at film side edges, while also reducing the need for drying. Furthermore, by providing such high shear rates, the viscosity of the MFC dispersion is reduced, leading to an improved thickness distribution, and thus a better film quality.

In particular, the method of the present disclosure enables production of an improved free-standing MFC film as well as production of an improved MFC coating on a substrate. An improved casting profile (i.e. reduced unevenness of the casting profile) may be obtained and the blockage of the casting device and associated channels may be reduced. By subjecting a viscous liquid in the form of an MFC dispersion to shear-force mixing in the casting chamber of the casting device, aggregated or agglomerated fibrils may be separated from each other by being impacted by shear forces provided by the shear-force mixing in the casting chamber. Thereby, the amount and/or size of flocs and bundles in the fibrous dispersion may be reduced in the casting chamber, i.e. the amount and/or size of flocs and bundles in the fibrous dispersion, may be reduced immediately before casting of the fibrous dispersion onto a substrate. Since the decomposition of flocs and bundles is provided in the casting chamber, i.e. immediately before casting, the time for renewed self-aggregation or agglomeration is very limited.

There is also provided improved wet edge quality since levelling at edges can be controlled and adjusted more precisely. This will improve yield but also winding and reel quality for the dry film. For a wide web, the difference between side edge thickness and e.g. average film thickness for dry film is significantly improved.

The method may further comprise feeding the MFC dispersion from a vessel through a feeding pipe towards the film forming device using a pump, whereby the MFC dispersion is exposed to a shear rate of at least 10 s⁻¹ in the feeding pipe.

The first shearing step may be provided by means of at least one of a rotating screen, a dispersing homogenizer, a static mixer and a mesh filter.

The first shearing step may be provided by a combination of two or more of the above mentioned shearing devices, which may be connected in series.

The third shearing step may be provided by means of at least one of a narrow flow channel, a lip channel, a channel formed by the substrate and a coating blade, a channel formed by the substrate and a coating bar, a channel formed by the substrate and a coating rod or a channel formed by the substrate and a slot die lip.

The second shearing step may be provided by means of a rotatable rod inside a chamber of the film forming device, by means of a narrow flow channel inside a slot die of the film forming device that accelerates the MFC dispersion flow into movement, or by means of a gap between the movable substrate and an object in the film forming device.

The deceleration of the distributed MFC dispersion may comprise reducing shear in the MFC dispersion to below about 20% of an average shear provided in the second shearing section, preferably to below about 10%, below about 5% or below about 1% of said average shear.

At least one of the shearing steps, preferably all of the shearing steps, may be performed under closed conditions, whereby ambient air is prevented from contacting the MFC dispersion.

In particular, the second shearing step may be performed under closed conditions. Furthermore, the third shearing step may be performed under closed conditions. Preferably, also the first shearing step may be performed under closed conditions.

The substrate may be an endless belt, and the method may further comprise passing the deposited MFC dispersion through a drying zone to form the MFC film and subsequently separating the MFC film from the substrate.

The substrate may be formed of a metal or polymer material.

Alternatively, the substrate may be a flexible web, wherein the method may further comprise passing the deposited MFC dispersion through a drying zone to form the MFC film and subsequently forming a coil of the flexible web coated with the MFC film.

The web may be formed of a cellulose based material, such as paper or paperboard sheet, a polymer film, a textile sheet, a nonwoven sheet, a polymer membrane or a ceramic substrate.

The viscosity of the MFC dispersion may be greater than 1.1 Pas at a shear rate of 100 s⁻¹, greater than 0.4 Pas at a shear rate of 400 s⁻¹ or greater than 0.2 at a shear rate of 1000 s⁻¹.

The MFC of the MFC dispersion may comprise, consist essentially of, or consist of, non-derivatized MFC.

While MFC is normally produced from wood cellulose fibers, both from hardwood or softwood fibers, it can also be made from microbial sources, agricultural fibers such as wheat straw pulp, bamboo, sugar beet, bagasse, or other non-wood fiber sources. It is preferably made from pulp including pulp from virgin fiber, e.g. mechanical, chemical and/or thermomechanical pulps. It can also be made from broke or recycled paper. Preferably, the MFC is made from softwood or hardwood fibers.

The shearing steps may be performed at a temperature of the MFC dispersion of 25-95 deg C., preferably 30-85 deg C.

The method may further comprise pre-distributing the MFC dispersion by dividing the MFC dispersion into at least two flow channels, wherein said at least two flow channels have openings into the film forming device upstream of the second shearing step, said openings being laterally spaced from each other.

At least one of the shearing steps may provide a shear rate of about 10 s⁻¹ to about 20 s⁻¹, about 20 s⁻¹ to about 30 s⁻¹, about 30 s⁻¹ to about 100 s⁻¹, about 100 s⁻¹ to about 200 s⁻¹, about 200 s⁻¹ to about 1000 s⁻¹, about 1000 s⁻¹ to about 5000 s⁻¹, about 5000 s⁻¹ to about 10000 s⁻¹, about 10000 s⁻¹ to about 50000 s⁻¹, about 50000 s⁻¹ to about 70000 s⁻¹ or about 70000 s⁻¹ to about 100000 s⁻¹.

In the method, a film longitudinal direction may be defined as a direction parallel with the direction in which the substrate is moving relative to the film forming device, wherein a film width direction is defined as a direction perpendicular to the film longitudinal direction, wherein a film edge portion extends in the direction perpendicular to the longitudinal direction by a distance of 0.5-10 mm from the outermost edge of the film, wherein an average film thickness is defined as an average thickness of the film across an entire film width, wherein a side edge thickness is defined as an average thickness of the edge portion, along the film width direction, and wherein the side edge thickness differs from the average film thickness by less than 20% of the average film thickness.

The side edge thickness and the average film thickness should be measured without any part of the edge portion being cut away from the film. For example, the side edge thickness and average film thickness may be measured while the film is still supported by the substrate, such as when the film is still wet or when the film has been subjected to drying. Alternatively, the film may be measured after having been separated from the substrate, but without any cutting-away of edge portions.

According to a second aspect, there is provided an MFC film obtainable by the process as described above.

According to a third aspect, there is provided a system for casting an MFC film on a substrate, comprising a vessel, configured to hold an MFC dispersion having a solids content of about 2.5-25% by weight, preferably about 2.5-15% by weight, about 2.5-10% by weight or about 2.5-8% by weight and a viscosity which is above about 4 Pas at a shear rate of 20 s⁻¹, a pump, connected to the vessel to receive the MFC dispersion from the vessel, a first shearing section, downstream of the pump, configured to expose the MFC dispersion to a shear rate of above 10 s⁻¹, preferably above 20 s⁻¹ or above 30 s⁻¹; and a film forming device. The film forming device comprises a distribution section, configured to laterally distribute the MFC dispersion; a second shearing section, configured to expose the distributed MFC dispersion to a shear rate of above 100 s⁻¹, preferably above 200 s⁻¹; a deceleration section, subsequent to the second shearing section, configured to decelerate the distributed MFC dispersion, such that the shear rate is reduced; a third shearing section, configured to expose the distributed MFC dispersion to a shear rate of above 100 s⁻¹, preferably above 200 s⁻¹; and a deposition section, configured to deposit the MFC dispersion on the substrate, while moving the substrate relative to the film forming device, such that a wet MFC film is formed on the substrate.

The system may further comprise a pre-distribution section, comprising a manifold having an input channel connected to the first shearing section and at least two output channels, which are connected to the distribution section, wherein openings form the output channels into the distribution section are laterally spaced from each other.

In the system, at least one of the shearing sections is configured to provide a shear rate of about 10 s⁻¹ to about 20 s⁻¹, about 20 s⁻¹ to about 30 s⁻¹, about 30 s⁻¹ to about 100 s⁻¹, about 100 s⁻¹ to about 200 s⁻¹, about 200 s⁻¹ to about 1000 s⁻¹, about 1000 s⁻¹ to about 5000 s⁻¹, about 5000 s⁻¹ to about 10000 s⁻¹, about 10000 s⁻¹ to about 50000 s⁻¹, about 50000 s⁻¹ to about 70000 s⁻¹ or about 70000 s⁻¹ to about 100000 s⁻¹.

According to a fourth aspect, there is provided an MFC film having a longitudinal direction, which is parallel with a production direction of the film and a width direction, which is perpendicular to the longitudinal direction, wherein an edge portion of the film extends in the direction perpendicular to the longitudinal direction by a distance of 0.5-10 mm, preferably 0.5-8 mm or 0.5-5 mm, from the outermost edge of the film, wherein an average film thickness is defined as an average thickness of the film across the entire width, and wherein a side edge thickness is defined as an average thickness of the edge portion, along the width direction. The side edge thickness differs from the average film thickness by less than 20% of the average film thickness.

The average film thickness, as well as the side edge thickness should preferably be measured without any part of the edge portion being cut away or otherwise severed. Such cutting away is readily identifiable.

The film may have a weight in the range of about 4-80 g/m², which may correspond to a thickness in the range of about 5-60 μm.

The average film thickness may be about 5-60 μm, preferably about 10-50 μm, about 15-45 μm or about 20-40 μm.

A film weight may be about 4-80 g/m², preferably about 8-67 g/m², about 12-60 g/m², about 16-53 g/m² or about 20-45 g/m².

A medium content of the film may be about 0.1-15% by weight, preferably about 1-12% by weight or about 2-10% by weight.

Measurements in terms of % by weight for a dry film are given in relation to the dry weight of the film.

A film forming component content of the film may be at least about 85-99.9% by weight.

The film forming component may comprise at least 50% by weight of MFC, preferably at least 60%, at least 70% or at least 80% MFC.

Hence, in some embodiments, an MFC content of the dry film may be at least about 42.5% by weight. In other embodiments, the MFC content of the dry film may be at least about 79.92% by weight.

A film width may be about 0.3-4 m, preferably 0.5-4 m, 1-4 m or 2-4 m.

### BRIEF DESCRIPTION OF THE DRAWINGS

FIG. 1 is a schematic diagram of a system for producing an MFC film.

FIG. 2 is a schematic diagram of a film forming device 4 according to a first embodiment.

FIG. 3 is a schematic diagram of a film forming device 4 according to a second embodiment.

FIGS. 4a-4b schematically illustrate a film forming device.

FIG. 5 schematically illustrates another version of the film forming device.

FIG. 6 is a schematic cross sectional view of a substrate supporting a film.

### DETAILED DESCRIPTION

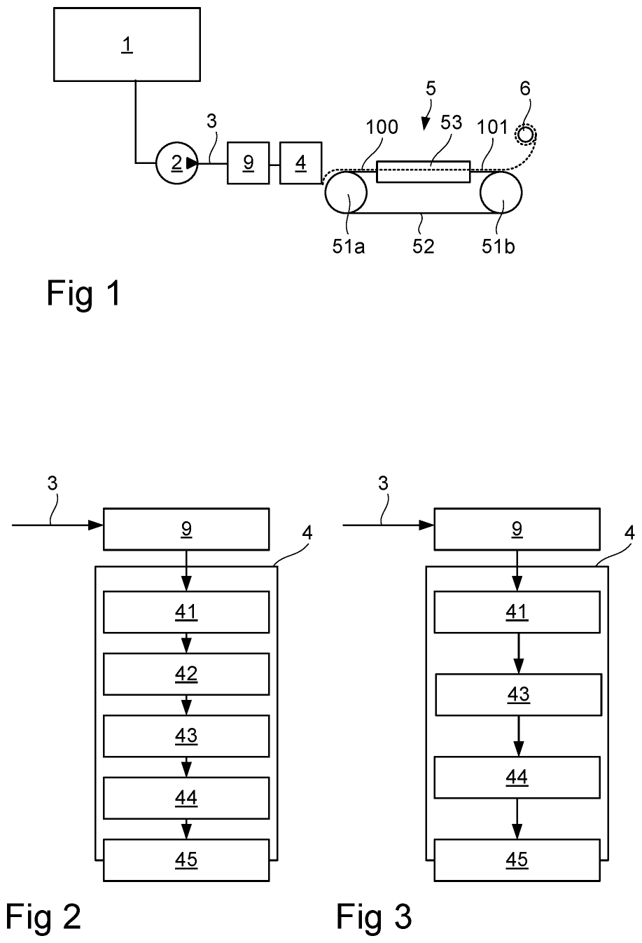

FIG. 1 schematically illustrates an equipment for manufacturing an MFC film. The equipment comprises a vessel 1, in which an MFC dispersion is provided. A pump 2 is used to convey the MFC dispersion through a feeding pipe 3 to a film forming device 4, through which the MFC dispersion is applied as a wet film 100 to a substrate 52, which may form part of a belt dryer 5.

The vessel 1 may comprise an agitator rotor. Such rotor may be provided as any known agitator type that works with high-viscous shear thinning dispersions.

As an alternative, there can be a storage or supply vessel (not shown) provided upstream of the vessel 1, in which the chemicals may be dosed, and from which the MFC dispersion is pumped to the vessel 1, which may then constitute a feed vessel from which the MFC dispersion is fed towards the forming device. Yet another option is to dose and mix the chemicals in the pipeline between storage or supply vessel and the vessel 1. In the vessel 1, one or more chemicals may be added to the MFC dispersion. Alternatively, or additionally, it is possible to add chemicals downstream of the vessel 1, e.g. immediately upstream or downstream of the pump 2; in the channel between the pump and the film forming device or immediately upstream of the film forming device.

Non-limiting examples of such chemicals that can be added may be softeners and plasticizers, such as glycols, sugar alcohols such as sorbitol or polysaccharides such as sorbitol or glucose, film forming agents such as PVOH, carboxymethylated cellulose or methylcellulose, fillers, pigments, retention chemicals and dispersants or other polyelectrolytes, latexes, cross-linkers, optical dyes, fluorescent whitening agents, de-foaming chemicals, salts, pH adjustment chemicals, surfactants, biocides and/or optical chemicals.

It is also possible that the MFC dispersion may have additives already dosed and mixed into it during MFC production, in which case less or no additives need to be added in the vessel(s) that are related to the various stages of the film forming process.

The pump 2 can be any type of positive displacement pump that generates non-pulsating flow and operates with high-viscous materials. Such pump types are for example screw pumps, progressive cavity pumps or excentric screw pumps or mono pumps. The pumping solution can optionally feature additional feeding elements, such as a feeding screw at the suction side of the pump, taking care of continuous material feed from the feed tank into the pump.

In the illustration, the substrate 52 forms part of a dryer 5, such as a belt dryer, in which the substrate 52 may be an endless belt formed of metal or polymer material. The belt 52 may run between a pair of belt pulleys 51a, 51b and through a drying zone 53, which provides a climate (in terms of temperature, pressure and flow) that is adapted for removing the liquid part of the MFC dispersion, so as to leave a film 101 that is sufficiently dry for being stripped off the substrate 52 and subsequently wound onto a reel 6. Before the drying step, the wet film may be subjected to a press dewatering step. Prior to such press dewatering, the wet film can be heated or subjected to hot air in order to facilitate the mechanical dewatering.

Between the stripping from the substrate 52 and the winding onto the reel 6, the film may undergo further processing steps, such as stretching, further drying or the like.

Alternatively, the substrate 52 may be a continuous sheet or film material on which the MFC dispersion is to form an MFC film that is to remain attached to the substrate 52. Non-limiting examples of such substrates include paper, cardboard, textile, nonwoven or polymer film materials. The substrate may also be a continuous MFC film, which may consist of one or more layers. Such a substrate may be used as a standalone substrate or be formed on any of the other substrate types mentioned above.

FIG. 2 schematically illustrates a film forming device 4, which is connected to the feed line 3 from the pump 2.

The film forming device 4 is preceded by a first shearing section 9, configured to provide a shear rate of more than 10 s⁻¹, preferably more than 20 s⁻¹ or more than 30 s⁻¹. The first shearing section 9 may be configured to provide a shear rate of up to about 100000 s⁻¹, about 70000 s⁻¹, about 50000 s⁻¹, about 10000 s⁻¹, about 5000 s⁻¹ or about 1000 s⁻¹. Thus, the first shearing section 9 may be configured to provide a shear rate of about 10 s⁻¹ to about 20 s⁻¹, about 20 s⁻¹ to about 30 s⁻¹, about 30 s⁻¹ to about 100 s⁻¹, about 100 s⁻¹ to about 200 s⁻¹, about 200 s⁻¹ to about 1000 s⁻¹, about 1000 s⁻¹ to about 5000 s⁻¹, about 5000 s⁻¹ to about 10000 s⁻¹, about 10000 s⁻¹, to about 50000 s⁻¹, about 50000 s⁻¹ to about 70000 s⁻¹ or about 70000 s⁻¹ to about 100000 s⁻¹.

The first shearing section 9 may comprise a screen, a dispersing homogenizer, a static mixer or a mesh filter.

Where a rotating screen is used, it is recommended to use a slot maximum width of 0.25 mm, which produces an average MFC dispersion flow through the screen of more than 0.002 m/s when a total slit area is 0.00612 m² and the flow rate though the screen is more than 1 l/min. In some embodiments, a distance to the film forming device 4 from the first shearing section 9 may be no more than 2 m. It may be preferred if a time it takes for the flow to move from the first shearing step to the film forming device is less than 10 seconds, preferably less than 5 seconds or less than 2 seconds.

Various types of rotating screen devices are known.

For the purpose of the present disclosure, as a non-limiting example, shear rates as mentioned above, for materials as mentioned above may be achieved using a closed rotor and radial vane pulsation elements and screen basket made by rods with 3.6 mm thickness that are 0.25 m apart, thus forming slits of 0.25 mm through which MFC dispersion may flow.

A total open area of slits may be 0.00612 m² and MFC flow may be approx. 2 l/min, creating an average shear rate of 22 s⁻¹ through the slits of screen basket.

Another example of a device that can be used for the first shearing section 9 is a screen having an open rotor with foils and screen basket made by rods with 2.5 mm thickness that are 0.25 mm apart, thus forming slits of 0.25 mm. A total open area may be 0.00315 m². MFC dispersion or dispersion flow may be approx. 2 l/min, creating average shear rate 42 s⁻¹ through the slits.

Where a static mixer, such as a IMAMIX DN15R½″ TYPE B6 PN10 HST, is used, a distance to slot input of no more than 1 m is recommended. Hence, such static mixers are known, and typically comprise a channel enclosing an approximately helical or otherwise spiral vane.

A homogenizing mixer that follows the same principle as the screen can also be used, and may often present a smaller cavity volume. Such a mixer also has a stator that works as a screen and can have holes or slits through which the MFC flows, thus generating the shear. A homogenizing mixer can also have two stator elements (screen) and two (or several) rotor elements, in a way that a first one forms an inner rotor and stator and a second one forms an outer rotor and stator.

The film forming device 4 comprises a cross machine distribution section 41, which is configured to distribute the MFC dispersion in the cross-machine direction. Typically, the cross-machine distribution section 41 may distribute the MFC dispersion over a width corresponding to an intended width of the MFC film.

The cross-machine direction distribution section 41 may be configured to maintain a shear rate of more than 10 s⁻¹.

Subsequently to the cross machine direction distribution, a second shearing section 42 is configured to provide a shear rate of more than 100 s⁻¹, preferably more than 200 s⁻¹. The second shearing section 42 may be configured to provide a shear rate of up to about 100000 s⁻¹, about 70000 s⁻¹, about 50000 s⁻¹, about 10000 s⁻¹, about 5000 s⁻¹ or about 1000 s⁻¹. Thus, the second shearing section 42 may be configured to provide a shear rate of about 10 s⁻¹ to about 20 s⁻¹, about 20 s⁻¹ to about 30 s⁻¹, about 30 s⁻¹ to about 100 s⁻¹, about 100 s⁻¹ to about 200 s⁻¹, about 200 s⁻¹ to about 1000 s⁻¹, about 1000 s⁻¹ to about 5000 s⁻¹, about 5000 s⁻¹ to about 10000 s⁻¹, about 10000 s⁻¹ to about 50000 s⁻¹, about 50000 s⁻¹ to about 70000 s⁻¹ or about 70000 s⁻¹ to about 100000 s⁻¹.

The second shearing section 42 may comprise a rotatable rod inside a chamber of the film forming device 4, or a narrow flow channel inside a slot die applicator that accelerates the MFC dispersion into movement.

As another option, the distribution section 41 and the second shearing section 42 may be formed as one step, e.g. by providing a plurality of constricted channels from the central inlet to the various points along the width of the film forming device.

Alternatively, the second shearing section 42 may be formed by a gap between a static element and the movable substrate 52.

The film forming device 4 further comprises a shear release section 43, which is configured to decelerate the flow in the film forming device 4. The shear release section 43 may be provided in the form of a portion having a greater flow area, or even a small buffer space, such that a flow speed of the MFC dispersion is reduced.

The film forming device 4 further comprises a third shearing section 44, which may be configured to provide a shear rate of more than 100 s⁻¹, preferably more than 200 s⁻¹. The third shearing section 44 may be configured to provide a shear rate of up to about 100000 s⁻¹, about 70000 s⁻¹, about 50000 s⁻¹, about 10000 s⁻¹, about 5000 s⁻¹ or about 1000 s⁻¹. Thus, the third shearing section 44 may be configured to provide a shear rate of about 10 s⁻¹ to about 20 s⁻¹, about 20 s⁻¹ to about 30 s⁻¹, about 30 s⁻¹ to about 100 s⁻¹, about 100 s⁻¹ to about 200 s⁻¹, about 200 s⁻¹ to about 1000 s⁻¹, about 1000 s⁻¹ to about 5000 s⁻¹, about 5000 s⁻¹ to about 10000 s⁻¹, about 10000 s⁻¹ to about 50000 s⁻¹, about 50000 s⁻¹ to about 70000 s⁻¹ or about 70000 s⁻¹ to about 100000 s⁻¹.

The third shearing section 44 may comprise a narrow flow channel, a lip channel, a channel formed by the substrate and a coating blade, a bar or a rod.

The film forming device also comprises a film deposition section 45, which may comprise a slot-die applicator, a rod applicator or a metering blade applicator. The film deposition section may have a width corresponding to an intended width of the MFC film.

Where a slot-die applicator is used, a pressure on the order of 1-4.5 bar, preferably 1-2.5 bar, may be used.

Some shearing may also take place within in the film deposition section 45, or in the gap formed between substrate and the applicator. In the case of slot die casting, it is possible to provide a small vacuum on the backside of a casting meniscus.

It is possible to add one or more chemicals in or between any of the shearing sections 9, 42, 44. Such chemicals may be one or more of the ones mentioned above for addition in the vessel 1.

After the wet film 100 has been deposited onto the substrate 52, it will be carried by the substrate through the drying zone 53. The drying zone may present a length and environment that are suitable for achieving the necessary drying to remove the liquid phase from the MFC dispersion to form the MFC film 101.

In cases where the substrate 52 is fixed to the dryer 5, such as in a belt dryer, the substrate 52 may be formed of a metal or polymer material, which may have a very smooth surface to facilitate removal of the film from the substrate 52. Subsequent to the drying, the MFC film 101 may be stripped off the substrate 52 in a manner which is known per se. The film may subsequently be processed further, such as by stretching, radiation, cutting, etc. so as to provide a film having desirable properties. The finished film 101 may be rolled onto a roll 6.

Alternatively, the substrate may be a material that is merely passed through the dryer 5, such as a polymer, fabric, nonwoven or paper based web, on which the MFC film 101 is to form an integrated coating. Subsequent to the drying, the MFC film 101 may be rolled or otherwise converted together with the substrate to form a roll of film covered substrate, or to form e.g. a plurality of sheets of film covered substrate.

Referring to FIG. 3, it is noted that the second shearing section 42, which was referred to in FIG. 2 may be dispensed with.

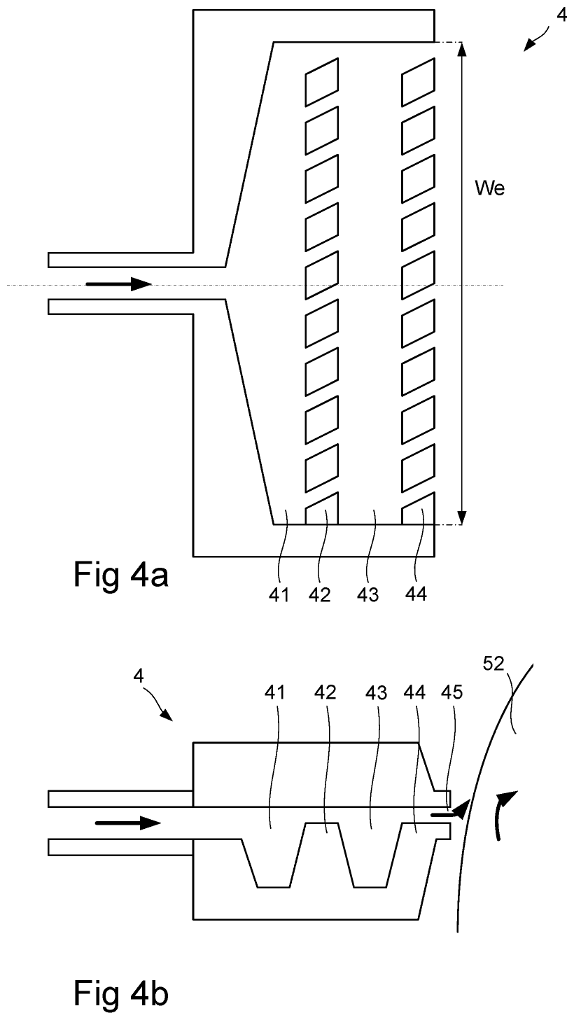

FIGS. 4a-4b schematically illustrate a film forming device 4. The film forming device may have an effective width We, which corresponds to a film width, and which may be slightly smaller than a width of the substrate 52.

The film forming device 4 comprises a distribution section 41, which may be formed as a space of increasing internal width, as seen along a flow direction, and which may have an internal height that is sufficient to provide some shear release.

The film forming device further comprises a shear release section 43, which may be formed as a chamber, having a greater flow area than the shear section 42, either directly following the distribution section 41 or following the shear section 42.

The film forming device further comprises another shear section 44, which may follow after the shear release section 43 and immediately upstream of the deposition section 45.

The deposition section 45 may be formed as a slot or a plurality of orifices, which open towards the substrate 52, and which are sufficiently close to the substrate to ensure that MFC dispersion fed through the deposition section 45 is evenly applied onto the substrate 52 surface.

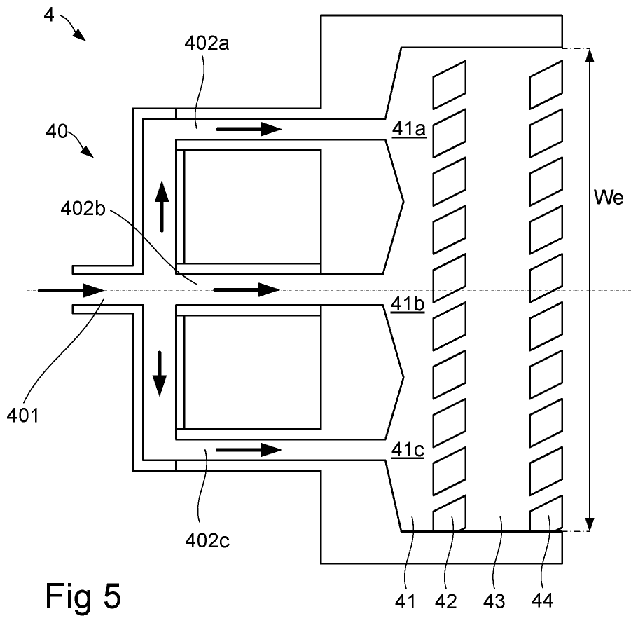

FIG. 5 schematically illustrates a further embodiment of a film forming device 4, wherein there is provided a pre-distributor 40, that operates as a manifold, which in this example provides one input channel 401 and three separate output channels 402a, 402b, 402c, each of which opens into the distribution section 41.

The openings of the output channels are spaced along the width direction We of the film forming device 4. The output channels may be evenly spaced, so as to ensure an even distribution of pressure into the distribution section 41.

Each of the channels 402a, 402b, 402c may open into a respective distribution chamber 41a, 41b, 41c, each of which having an increasing width, as seen along a flow direction.

The film forming device 4 illustrated in FIG. 5 is otherwise identical with that illustrated and described above with reference to FIGS. 4a-4b.

It is possible to add one or more chemical agents to the MFC dispersion upon its passage through any one of the shearing sections, in the distribution section or in the shear release section 43.

Referring to table 1 below, a plurality of test runs were made with various constellations of shearing sections being used.

In all tests, use was made of an MFC1 type MFC with a sorbitol additive and water as liquid. MFC and sorbitol content as percentage of solid matter as well as solid matter concentrations, temperatures, viscosities, shearing section type and shear rates are indicated in table 1. Qualitative results are presented based on visual inspection of the resulting film.

TABLE 1
Test results

| Test | 1 | 2 | 3 | 4 | 5 |
|---|---|---|---|---|---|
| Nanocellulose type | MFC1 | MFC1 | MFC1 | MFC1 | MFC1 |
| Nanocellulose content | 85% | 85% | 85% | 82.5% | 85% |
| Additives | Sorbitol | Sorbitol | Sorbitol | Sorbitol | Sorbitol |
| Additive content | 15% | 15% | 15% | 17.5% | 15% |
| Concentration | 3.7 | 3.7 | 3.8 | 3.6 | 4.72 |
| Temperature | 33 | 32 | 35 | 36 | 38 |
| Viscosity (20 1/s) Pas | 4.5 | 4.5 | 4.3 | 4.0 | |
| Viscosity (100 1/s) Pas | 1.7 | 1.7 | | 1.3 | 3.8 |
| Viscosity (400 1/s) Pas | 0.66 | 0.66 | | 0.51 | 1.1 |
| Viscosity (1000 1/s) Pas | 0.35 | 0.35 | | 0.29 | 0.53 |
| Run speed (m/min) | 4 | 4 | 4.5 | 5 | 6 |
| Shearing step 1 (on/off) | off | on | on | on | on |
| Shearing step 1 type | | Rotating screen | Rotating screen | Rotating screen | Rotating screen |
| | | with 0.25 mm | with 0.25 mm | with 0.25 mm | with 0.25 mm |
| Shearing step 1 shear rate (1/s) | | 167 | 38 | 27 | 42 |
| Shearing step 2 (on/off) | off | off | on | off | on |
| Shearing step 2 type | | | Slot die lip | | Slot die lip |
| | | | 500 μm thickness | | 700 μm thickness |
| Shearing step 2 shear rate (1/s) | | | 199 | | 114 |
| Shearing step 3 (on/off) | on | on | on | on | on |
| Shearing step 3 type | Slot die lip | Slot die lip | Slot die lip | Slot die lip | Slot die lip |
| | 300 μm thickness | 300 μm thickness | 500 μm thickness | 300 μm thickness | 700 μm thickness |
| Shearing step 3 shear rate (1/s) | 604 | 604 | 199 | 535 | 114 |
| Web breaks (yes/no) | yes | no | no | yes | no |
| Deposits/flocs (yes/no) | yes | no | no | no | no |
| Wet film quality | | | | | |
| Streaks | yes | no | no | No | no |
| Profile | n.a. | Bad | Good | Bad | Good |
| Edges | n.a. | Bad | Good | Bad | good |

From table 1, it was learned that attempts according to test 1, i.e. to extrude a film using neither the first nor second shearing steps 9, 42, provided poor results.

Using only the first and third shearing steps 9, 44, as in tests 2 and 4, an improvement, but still not an acceptable edge profile was obtained.

By using all three shearing steps 9, 42, 44, as in tests 3 and 5, provided excellent results.

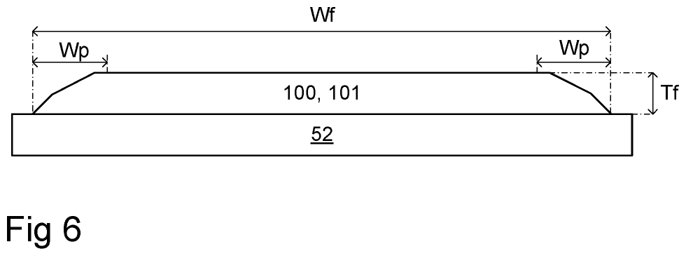

Referring to FIG. 6, there is schematically illustrated a cross sectional view, in a plane perpendicular to the movement direction of the substrate in FIG. 1, of a substrate 52 carrying a film 100, 101.

FIG. 6 may illustrate the film 100 in the wet state, or the film 101 in a dry state. FIG. 6 illustrates the total width of the film Wf, the width Wp of the film side edge portions and the film thickness Tf of the film. While the total width Wf of the film includes the edge portions, the edge portions may be defined as having a width Wp of about 0.5-10 mm.

Hence, an average film thickness may be defined as an average film thickness across the entire film width Wf, and a side edge thickness may be defined as an average thickness of the side edge portions Wp.

It is understood that the term “thickness” as used herein refers to actual, uncompressed thickness.

Thickness of the dry film may be measured using, as non-limiting examples, white light interferometry, laser profilometry, or optically by cutting a sample in cross-machine directional line (either cast in resin or not) and microscopic imaging (e.g. scanning electron microscopy or other applicable method) of the cut section in thickness direction.

The side edge thickness may differ from the average film thickness by less than 20% of the average film thickness.

The average dry film thickness may be on the order of 5-60 μm, 15-20 μm, preferably 20-60 μm, 10-50 μm, 30-50 μm, 15-45 μm or 20-40 μm.

Particular average dry film thicknesses may be 5-10 μm, 10-15 μm, 15-20 μm, 20-25 μm, 25-30 μm, 30-35 μm, 35-40 μm, 40-45 μm, 45-50 μm, 50-55 μm or 55-60 μm.

A dry film weight may be on the order of 4-80 g/m², preferably 8-67 g/m², 12-60 g/m², 16-53 g/m² or 20-45 g/m².

Particular dry film weights may be 4-10 g/m², 10-20 g/m², 20-30 g/m², 30-40 g/m², 40-50 g/m², 50-60 g/m², 60-70 g/m² or 70-80 g/m².

A medium content of the dry film may be on the order of 0.1-15% by weight, preferably 1-12% by weight, or 2-10% by weight.

Particular medium content of the dry film may be on the order of 0.1-1% by weight, 1-2% by weight, 2-3% by weight, 3-4% by weight, 4-5% by weight, 5-6% by weight, 6-7% by weight, 7-8% by weight, 8-9% by weight, 9-10% by weight, 10-11% by weight, 11-12% by weight, 12-13% by weight, 13-14% by weight or 14-15% by weight.

A film forming component content of the dry ay be at least 85-99.9% by weight, with the remainder being medium.

In particular, the dry film may have an MFC content of 40-50% by weight, 50-60% by weight, 60-70% by weight, 70-80% by weight, 80-90% by weight, 90-95% by weight or 95-99% by weight.

A width of the dry film may be about 0.3-4 m, preferably 0.5-4 m, 1-4 m or 2-4 m.

Particular film widths may be 0.3-0.5 m, 0.5-1 m, 1-1.5 m, 1.5-2 m, 2-2.5 m, 2.5-3 m, 3-3.5 m or 3.5-4 m.

The dry film may be considered as a thin continuous sheet formed material. Depending on its composition, purpose and properties, the dry film may also be considered as a thin paper or web, or even as a membrane.

1. A method of casting an MFC film on a substrate, comprising:
providing an MFC dispersion having a solids content of about 2.5-25% by weight and a viscosity which is above about 4 Pas at a shear rate of 20 s⁻¹;
exposing the MFC dispersion to a first shearing step, which provides a shear rate of above 10 s⁻¹;
introducing the MFC dispersion into a film forming device;
in the film forming device, laterally distributing the MFC dispersion;
in the film forming device, subsequent to the laterally distributing, exposing the distributed MFC dispersion to a second shearing step, providing a shear rate of above 100 s⁻¹;
in the film forming device, subsequent to the second shearing step, decelerating the distributed MFC dispersion, such that the shear rate is reduced;
in the film forming device, subsequent to the decelerating step, exposing the MFC dispersion to a third shearing step, providing a shear rate of above 100 s⁻¹; and
simultaneously with, or subsequent to, the third shearing step, depositing the MFC dispersion on the substrate, while moving the substrate relative to the film forming device, such that a wet MFC film is formed on the substrate.

2. The method as claimed in claim 1, further comprising feeding the MFC dispersion from a vessel through a feeding pipe towards the film forming device using a pump, whereby the MFC dispersion is exposed to a shear rate of at least 10 s⁻¹ in the feeding pipe.

3. The method as claimed in claim 1, wherein the first shearing step is provided with a rotating screen, a dispersing homogenizer, a static mixer, a mesh filter, or a combination thereof.

4. The method as claimed in claim 1, wherein the third shearing step is provided with a flow channel, a lip channel, a channel formed by the substrate and a coating blade, a channel formed by the substrate and a coating bar, a channel formed by the substrate and a coating rod, a channel formed by the substrate and a slot die lip, or a combination thereof.

5. The method as claimed in claim 1, wherein the second shearing step is provided with a rotatable rod inside a chamber of the film forming device, with a flow channel inside a slot die of the film forming device that accelerates the MFC dispersion flow into movement, or with a gap between the movable substrate and an object in the film forming device.

6. The method as claimed in claim 1, wherein said decelerating the distributed MFC dispersion comprises reducing shear in the MFC dispersion to below about 20% of an average shear provided in the second shearing step, preferably to below about 10%, below about 5% or below about 1%, of said average shear.

7. The method as claimed in claim 1, wherein at least one of the shearing steps, are performed under closed conditions, whereby ambient air is prevented from contacting the MFC dispersion.

8. The method as claimed in claim 1, wherein the substrate is an endless belt, and wherein the method further comprises passing the deposited MFC dispersion through a drying zone to dry the MFC film and subsequently separating the dried MFC film from the substrate.

9. The method as claimed in claim 8, wherein the substrate is formed of a metal or polymer material.

10. The method as claimed in claim 1, wherein the substrate is a flexible web, and wherein the method further comprises passing the deposited MFC dispersion through a drying zone to dry the MFC film and subsequently forming a coil of the flexible web coated with the dried MFC film.

11. The method as claimed in claim 10, wherein the web is formed of a cellulose based material, a polymer film, a textile sheet, a nonwoven sheet, a polymer membrane, or a ceramic substrate.

12. The method as claimed in claim 1, wherein the viscosity of the MFC dispersion is greater than 1.1 Pas at a shear rate of 100 s⁻¹.

13. The method as claimed in claim 1, wherein the shearing steps are performed at a temperature of the MFC dispersion of 25-95 deg C.

14. The method as claimed in claim 1, further comprising:
pre-distributing the MFC dispersion by dividing the MFC dispersion into at least two flow channels, wherein said at least two flow channels have openings into the film forming device upstream of the second shearing step, said openings being laterally spaced from each other.

15. The method as claimed in claim 1, wherein at least one of the shearing steps provides a shear rate of about 10 s⁻¹ to about 20 s⁻¹.

16. The method as claimed in claim 1,
wherein a film longitudinal direction is defined as a direction parallel with a direction in which the substrate is moving relative to the film forming device,
wherein a film width direction is defined as a direction perpendicular to the film longitudinal direction,
wherein a film edge portion extends in the direction perpendicular to the longitudinal direction by a distance of 0.5-10 mm from an outermost edge of the film,
wherein an average film thickness is defined as an average thickness of the film across an entire film width,
wherein a side edge thickness is defined as an average thickness of the film edge portion, along the film width direction, and
wherein the side edge thickness differs from the average film thickness by less than 20% of the average film thickness.

17. (canceled)

18. A system for casting an MFC film on a substrate, comprising:
a vessel, configured to hold an MFC dispersion having a solids content of 2.5-25% by weight and a viscosity which is above about 4 Pas at a shear rate of 20 s⁻¹;
a pump, connected to the vessel and configured to receive the MFC dispersion from the vessel,
a first shearing section, downstream of the pump, configured to expose the MFC dispersion to a shear rate of above 10 s⁻¹; and
a film forming device, comprising:
a distribution section, configured to laterally distribute the MFC dispersion;
a second shearing section, configured to expose the distributed MFC dispersion to a shear rate of above 100 s⁻¹, and
a deceleration section, subsequent to the second shearing section, configured to decelerate the distributed MFC dispersion, such that the shear rate is reduced,
a third shearing section, configured to expose the distributed MFC dispersion to a shear rate of above 100 s⁻¹; and
a deposition section, configured to deposit the MFC dispersion on the substrate, while moving the substrate relative to the film forming device such that a wet MFC film is formed on the substrate.

19. The system as claimed in claim 18, further comprising:
a pre-distribution section, comprising a manifold having an input channel connected to the first shearing section and at least two output channels, which are connected to the distribution section, wherein openings form the output channels into the distribution section are laterally spaced from each other.

20. The system as claimed in claim 18, wherein at least one of the shearing sections is configured to provide a shear rate of about 10 s⁻¹ to about 20 s⁻¹.

21.-27. (canceled)
